(19) United States
(12) Patent Application Publication
(10) Pub. No.: US 2020/0411004 A1
(43) Pub. Date: Dec. 31, 2020

(54) CONTENT INPUT METHOD AND APPARATUS

(71) Applicant: Beijing Bytedance Network Technology Co., Ltd., Beijing (CN)

(72) Inventors: Yonghao LUO, Beijing (CN); Yangmao WANG, Beijing (CN); Haitao LUO, Beijing (CN)

(21) Appl. No.: 17/019,544

(22) Filed: Sep. 14, 2020

Related U.S. Application Data
(63) Continuation of application No. PCT/CN2019/078127, filed on Mar. 14, 2019.

(30) Foreign Application Priority Data
Mar. 15, 2018 (CN) 201810214705.1

(51) Int. Cl. G10L 15/22; G06F 3/0482; G06F 3/0489; G10L 15/26

(52) U.S. Cl. CPC G10L 15/22; G10L 15/26; G06F 3/0489; G06F 3/0482

(57) ABSTRACT

A content input method and a content input device are provided. The method includes the following steps. In a case where a display event of an input box is detected, the input box and a speech input control corresponding to the input box is displayed in response to the display event so that the user can directly perform a speech input operation on the first speech input control. Then, speech data inputted by the user is received in response to the speech input operation and the speech data inputted by the user is converted into display content displayable in a first input box, and the display content is displayed in the first input box.

The present application is a continuation of International Patent Application No. PCT/CN2019/078127 filed on Mar. 14, 2019, which claims priority to Chinese Patent Application No. 201810214705.1, filed on Mar. 15, 2018 with the Chinese Patent Office, both of which are incorporated herein by reference in their entireties.

### FIELD

The present disclosure relates to the technical field of speech input, and particularly to a content input method and a content input device.

### BACKGROUND

With development of the speech recognition technology, the accuracy of speech recognition is improved constantly, and more and more users are willing to input desired content in an input box by means of speech input. In the prior art, before performing a speech input operation, a user usually has to click on the input box to move an input cursor into the input box, and then find a speech input control preset in an activated input control board. After that, the user can input speech data through a speech input operation (such as a long press on the speech input control, etc.) on the speech input control.

In view of this, the user has to perform some operations before performing the speech input operation, resulting in a low input efficiency. In addition, due to differences between input methods, the speech input control may be provided in different positions on different input control boards. Therefore the user has to spend some energy in finding the position of the speech input control on the input control board. Furthermore, in some input methods, there is even no preset speech input control on the input control board, and thus the user cannot perform the speech input. Therefore, the conventional speech input methods are not friendly.

### SUMMARY

In view of this, a content input method and a content input device are provided according to embodiments of the disclosure, to increase an input efficiency of a user.

In order to solve the above problem, the following technical solutions are provided according to the embodiments of the present disclosure.

In a first aspect, a content input method is provided according to the embodiments of the present disclosure. The method includes: displaying an input box and a speech input control in response to a display event of the input box, where there is a preset correspondence between the input box and the speech input control; receiving speech data in response to a speech input operation on a first speech input control, where the first speech input control is a speech input control selected by a user, converting the speech data into display content displayable in a first input box, where the first input box corresponds to the first speech input control; and displaying the display content in the first input box.

In some possible embodiments, the displaying an input box and a speech input control includes: displaying the input box; detecting whether the input box is displayed; and displaying the speech input control in a case where the input box is displayed.

In some possible embodiments, the displaying an input box and a speech input control includes: displaying the input box; and displaying the speech input control in response to a triggering operation of the user on a shortcut key, where the shortcut key is associated with the speech input control.

In some possible embodiments, the displaying an input box and a speech input control includes displaying the input box and the speech input control at the same time.

In some possible embodiments, the first speech input control is displayed in the first input box, and a display position of the first speech input control in the first input box moves with an increase or a decrease of the display content in the first input box.

In some possible embodiments, a presentation of the speech input control includes a speech bubble, a loudspeaker or a microphone.

In some possible embodiments, the converting the speech data to display content displayable in the first input box includes: converting the speech data to obtain a conversion result; modifying the conversion result based on a semantic analysis on the conversion result and determining the modified conversion result as the display content displayable in the first input box.

In some possible embodiments, the determining the modified conversion result as the display content displayable in the first input box includes: displaying the modified conversion result; and determining the conversion result selected by the user from the multiple modified conversion results in response to a selection operation of the user for the modified conversion results and determining the conversion result selected by the user as the display content displayable in the first input box, where the multiple modified conversion results have similar pronunciations, and/or, the multiple modified conversion results are search results obtained through an intelligent search.

In some possible embodiments, the displaying the display content in the first input box includes: detecting whether other display content exists in the first input box when the user inputs the speech data; and substituting the display content for the other display content in a case where the other display content exists in the first input box.

In a second aspect, a content input device is provided according to the embodiments of the present disclosure. The device includes: a first display module, a receiving module, a conversion module and a second display module. The first display module is configured to display an input box and a speech input control in response to a display event of the input box, where there is a preset correspondence between the input box and the speech input control. The receiving module is configured to receive speech data in response to a speech input operation on a first speech input control, where the first speech input control is a speech input control selected by a user. A conversion module is configured to convert the speech data into display content displayable in a first input box, where the first input box corresponds to the first speech input control. The second display module is configured to display the display content in the first input box.

In some possible embodiments, the first display module may include: a first display unit, a detection unit and a second display unit. The first display unit is configured to display the input box. The detection unit is configured to detect whether the input box is displayed. The second display unit is configured to display the speech input control in a case where it is detected that the input box is displayed.

In some possible embodiments, the first display module may also include: a third display unit and a fourth display unit. The third display unit is configured to display the input box. The fourth display unit is configured to display the speech input control in response to a triggering operation of the user on a shortcut key, where the shortcut key is associated with the speech input control.

In some possible embodiments, the first display module is configured to display the input box and the speech input control at the same time.

In some possible embodiments, the conversion module may include: a conversion unit, and a modification unit. The conversion unit is configured to convert the speech data to obtain a conversion result. The modification unit is configured to modify the conversion result based on a semantic analysis on the conversion result and determine the modified conversion result as the display content displayable in the first input box.

In some possible embodiments, the modification unit may include: a display sub-unit, and a determining sub-unit. The display sub-unit is configured to display the modified conversion result. The determining sub-unit is configured to determine the conversion result selected by the user from the multiple modified conversion results in response to a selection operation of the user for the modified conversion results and determine the conversion result selected by the user as the display content displayable in the first input box; where the multiple modified conversion results have similar pronunciations, and/or, the multiple modified conversion results are search results obtained through an intelligent search.

In some possible embodiments, the first speech input control is displayed in the first input box and a display position of the first speech input control in the first input box is not fixed but moves with an increase or a decrease of the display content in the first input box.

In some possible embodiments, a presentation of the speech input control includes a speech bubble, a loudspeaker or a microphone or the like.

In some possible embodiments, the second display module may include: a content detection unit and a substitution unit. The content detection unit is configured to detect whether other display content exists in the first input box when the user inputs the speech data. The substitution unit is configured to substitute the display content for the other display content in a case where the other display content exists in the first input box.

It can be seen that the embodiment of the present disclosure has following advantages.

In the embodiment of the present disclosure, in a case where a display event of an input box occurs, the input box and a speech input control corresponding to the input box are displayed in responses to the display event, where there is a preset correspondence between the input box and the speech input control. In this way, the speech input control and the input box may be displayed to the user at the same time so that the user can directly perform a speech input operation on the first speech input control. Then, speech data inputted by the user is received in response to the speech input operation and the speech data inputted by the user is converted into display content displayable in a first input box, where the first input box corresponds to a first speech input control. Then the display content is displayed in the first input box. Therefore, since when the input box is displayed to the user, the speech input control corresponding to the input box is also displayed, the user can directly perform a speech input operation on the displayed speech input control, so as to achieve the speech input, thereby reducing operations required to be performed before the user performs the speech input operation and thus improving an input efficiency of the user. Furthermore, the user does not need to use the speech input control on an input control board to input the speech, so as to avoid a problem that the user cannot perform the speech input due to non-existent of the speech input control on some input control boards.

### BRIEF DESCRIPTION OF THE DRAWINGS

FIG. 1 is a schematic diagram of an exemplary application scenario according to an embodiment of the present disclosure;

FIG. 2 is a schematic diagram of an exemplary application scenario according to another embodiment of the present disclosure;

FIG. 3 is a schematic flow diagram of a content input method according to an embodiment of the present disclosure;

FIG. 4 shows a presentation of a speech recording popup window at a time when the user does not input speech data according to an embodiment of the present disclosure;

FIG. 5 shows a presentation of a speech recording popup window at a time when the user inputs speech data according to an embodiment of the present disclosure;

FIG. 6 is a schematic diagram of an exemplary software architecture applied to a content input method according to an embodiment of the present disclosure; and

FIG. 7 is a schematic architecture diagram of a content input device according to an embodiment of the present disclosure.

### DETAILED DESCRIPTION

When a user wants to input some content into an input box by means of speech input, the user may usually perform a long press on a speech input control on one of various input control boards to achieve a speech input. For this purpose, before performing the speech input operation, the user usually clicks on the input box to move an input cursor into the input box, at which time the input control board may also be activated and displayed, and then the user finds out a preset speech input control used for triggering a speech recognition from multiple input controls on the displayed input control board. After that, the user enables the speech recognition through a long press on the speech input control or other speech input operation, to perform the speech input.

The user has to click an input box and find out a speech input control before performing a speech input operation. After that, the user can perform a long press on the speech input control to start the speech input. So many operations results in a low input efficiency of the user. In addition, there are differences between existing input control boards, and thus the speech input control may be located in different positions on the different input control boards. In this case, the user has to find out the speech input control from the multiple controls on the input control board each time, which consume time and energy of the user, resulting in a poor user experience. In some input control boards, there is even no preset speech input control, and thus the user cannot perform the speech input when using the input control board. In view of this, for the user, the conventional speech input method is not friendly and the input efficiency of the user is low.

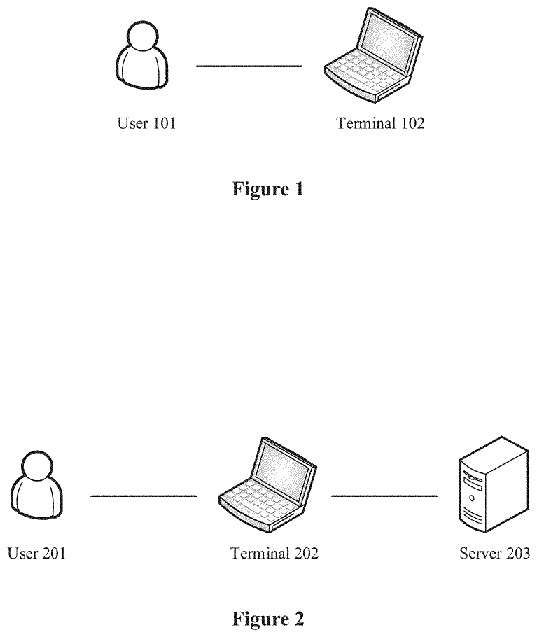

In order to solve the above technical problem, a speech input method is provided according to the present disclosure, to improve a speech input efficiency of a user. Taking an application scenario shown in FIG. 1 as an example, a display interface of a terminal 102 not only displays an input box when a display event of the input box is detected, but also displays a speech input control corresponding to the input box. When a user 101 wants to input a content into an input box on the terminal 102 by means of speech input, since the speech input control corresponding to the input box is displayed in the display interface of the terminal 102, the user 101 can directly long press the speech input control on the terminal 102 to enable the speech input. In response to the long press operation of the user 101 on the speech input control, the terminal 102 receives speech data inputted by the user 101 and converts the speech data into display content displayable in the input box. Then, the terminal 102 displays the display content in the input box. In this way, the user inputs the content in the input box by the means of speech input. Since the speech input control corresponding to the input box is displayed at the same time when the input box is displayed, the user 101 can directly perform the long press operation on the speech input control, to start the speech input. Compared with the conventional technology, in the technical solution of the present disclosure, the user 101 does not have to click the input box and find the speech input control from the multiple controls on the input control board before performing the speech input operation. In this way, not only the operations of the user 101 can be reduced, but also the time spent by the user 101 can be reduced, thereby improving the speech input efficiency of the user 101. Furthermore, the user does not need the speech input control on an input control board to perform the speech input, avoiding the problem that the user 101 cannot perform the speech input due to non-existent of the speech input control on some input control boards.

It should be noted that the above exemplary application scenario is only an exemplary description of the speech input method provided in the present disclosure and is not used to limit embodiments of the present disclosure. For example, the technical solution in the present disclosure may further be applied to the application scenario shown in FIG. 2. In the scenario, it is a server 203 that converts the speech data inputted by the user. Specifically, a terminal 202 may, in response to a long press operation of a user 201 on the speech input control, receive the speech data inputted by the user 201. Then the terminal 202 may send a conversion request for the speech data to the server 203 so as to request the server 203 to convert the speech data inputted by the user. After the server 203 responds to the conversion request, the terminal 202 sends the speech data to the server 203. The server 203 converts the speech data to obtain display content displayable in the input box and sends the display content to the terminal 202. After receiving the display content sent from the server 203, the terminal 202 displays the display content in the corresponding input box. It is understood that, in some scenarios involving a large amount of speech data, if the speech data is converted by the terminal 202, it may lead to a longer response time of the terminal 202 and affect a user experience. If the speech data is converted on the server 203 and the conversion result is sent to the terminal 202 for display, since a computation speed of the server 203 is much higher than that of the terminal, the response time of the terminal 202 to the speech input can be greatly reduced, thus further improving the user experience.

In order to make those skilled in the art better understand the technical solution of the present disclosure, the technical solutions according to the embodiments of the present disclosure will be described clearly and completely hereinafter in conjunction with the drawings in the embodiments of the present disclosure. Apparently, the described embodiments are only a part rather than all of embodiments of the present disclosure. Any other embodiments acquired by those skilled in the art based on the embodiments of the present disclosure without any creative work fall in the protection scope of the present disclosure.

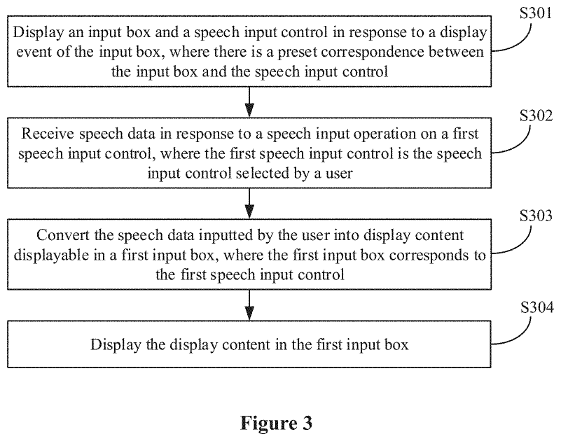

Reference is made to FIG. 3, which is a schematic flow diagram of a content input method according to an embodiment of the present disclosure. The method may include following steps S301 to S304.

In step 301, an input box and a speech input control are displayed in response to a display event of the input box, where there is a preset correspondence between the input box and the speech input control.

The display event of the input box is an event to display the input box in a display interface. Normally, in a case where an input box is required to be displayed in a display interface, the display event of the input box is generated. For example, in some exemplary scenarios, when a user opens a “Baidu” webpage, an input box of “Baidu it” on the “Baidu” webpage is required to be displayed. At this time, the display event of the input box is generated. The terminal responds to the event, to display the input box in the “Baidu” webpage.

When the display event of the input box is detected, the terminal may, in response to the event, display the input box and the speech input control corresponding to the input box. In the embodiment, non-restrictive examples of displaying the input box and the speech input control are provided below.

In a non-restrictive example, when the display event of the input box is detected, the input box is displayed on the display interface. When the terminal detects that the input box is displayed on the display interface, the speech input control corresponding to the input box is also displayed on the display interface. In the example, the input box and the display interface may be displayed at the same time in the form of a widget, facilitating application and promotion of products. It is understood that in practices, the input box and the speech input control cannot be displayed at the same time for there is always a certain time difference, but normally the time difference is so small that it is hard for a human eye to tell that the speech input control is displayed after the input box. Therefore, the input box and the speech input control seem to be displayed at the same time for the user.

In another non-restrictive example, when the display event of the input box is detected, the input box is displayed on the display interface and the speech input control corresponding to the input box is hidden. When a triggering operation of the user on a shortcut key for displaying the speech input control is detected, the speech input control is switched from a hidden state to a display state, that is, the speech input control is displayed on the display interface. In the example, the user may perform the corresponding operation on the shortcut key to control the hide and the display of the speech input control, thereby improving the user experience.

In another non-restrictive example, the display event of the input box may be bound to a corresponding speech input button in advance. In this case, when the display event of the input box is detected, the speech input button is triggered to be displayed on the current display interface. Therefore, the input box and the speech input control corresponding to the input box can be displayed on the display interface at the same time in response to the display event of the input box.

The correspondence between the input box and the speech input control may be preset by technician. In some examples, there may be a one-to-one correspondence between the input box and the speech input control.

In step S302, speech data is received in response to a speech input operation on a first speech input control, where the first speech input control is a speech input control selected by a user.

As an exemplary embodiment, when the user wants to input some content into the input box by the means of speech input, the user may perform the speech input operation on the first speech input control associated with the input box. The first speech input control is the speech input control selected by the user, and the speech input operation performed by the user may be the operations of clicking (for example, long press, single click, double click, etc.) the speech input control by the user. Then, the terminal responds to the speech input operation of the user and receives the speech data inputted by the user through invoking a speech receiver (such as a microphone) provided on the terminal.

It should be noted that, since the input box and the corresponding speech input control are displayed to the user before the user performs the speech input operation, the user can directly perform a triggering operation on the speech input control when the user wants to input the content into the input box on the terminal by means of speech input, thereby achieving the input of the speech data without operating with various input methods to achieve the speech input as the conventional technology. Therefore, not only the operations to be performed by the user are reduced, but also the time of the user is saved.

In some possible embodiments, in order to assist the user to quickly locate the speech input control, a position relation between the speech input control and the input box may be predetermined. For example, the first speech input control may be displayed in the input box, and the position of the speech input control in the input box may move with a decrease or an increase of the display content in the input box. Alternatively or additionally, a presentation of the speech input control may be predetermined. For example, the presentation of the speech input control may be determined as a speech bubble, a loudspeaker or a microphone or the like. In this case, the user can quickly locate the speech input control based on a specificity of the presentation of the speech input control, thereby facilitating a usage of the user and improving the user experience.

It should be noted that there are many ways for the user to input the speech data, which is not limited herein. For example, in some exemplary embodiments, the user may play the speech data recorded in advance, to perform the speech data input. Alternatively, the user may speak, and the voice of the user is the speech data inputted by the user.

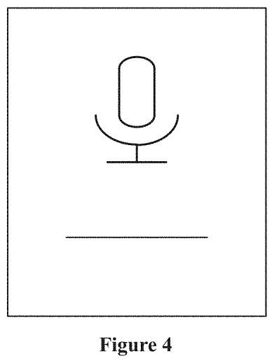

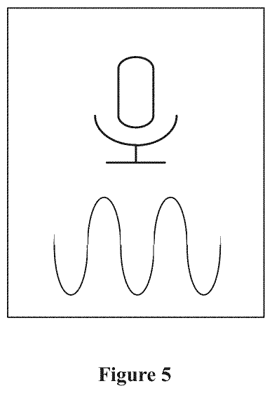

Moreover, in order to improve the user experience, after the user performs the triggering operation on the speech input control, a popup window may be displayed to prompt the user to input the speech data. In the embodiment, a speech recording popup window may be displayed to the user in response to the triggering operation of the user on the speech input control, where the speech recording popup window is used for prompting the user to perform the speech input and feeding back the speech recording situation to the user. It should be noted that, in order to show the user a difference between a situation that the speech data is inputted and a situation that the speech data is not inputted, a presentation of the speech recording popup window may be changed when the user inputs the speech data, to be different from that when the user does not input the speech data. In an example, the speech recording popup window may be as shown in FIGS. 4 and 5. FIG. 4 shows a presentation of a speech recording popup window at a time when the user does not input speech data according to an embodiment of the present disclosure. FIG. 5 shows a presentation of a speech recording popup window at a time when the user inputs speech data according to an embodiment of the present disclosure.

In step S303, the speech data inputted by the user is converted into display content displayable in a first input box, where the first input box corresponds to the first speech input control.

As an example, after being acquired, the speech data inputted by the user may be recognized using the Automatic Speech Recognition (ASR) technology by a speech recognition engine provided on the terminal or a server, to convert the speech data to the display content displayable in the first input box.

The display content displayable in the first input box is computer readable content including texts in various languages and/or images. The text included in a conversion result may be a combination of words, and also may be characters, such as all types of letters, numbers, symbols, character combinations such as expressing a “happy face”, and the like. The image included in the conversion result may be a variety of images or chat emoticons, and the like.

It should be noted that, in some scenarios, the display content displayable in different input boxes may be different. For example, on a webpage for filling personal information, there may be an input box for inputting a phone number and an input box for inputting a home address. Generally, only integral numbers from 0 to 9 are allowed to be displayed in the input box for inputting the phone number, excluding any Chinese characters. The input box for inputting a home address can include Chinese characters as well as numbers. Therefore, in converting the speech data to the display content, the display content is generally the content allowed to be displayed in the input box (i.e., the first input box), rather than content in any forms.

In practices, speech data may be converted into the computer readable input by using the speech recognition engine to obtain the content displayable in the input box. However in some cases, even though a recognition rate of the speech recognition engine is high, some content unexpected by the user may still occur in the obtained conversion result. For example, the user expects to input the content “ [symbol] ”, but the phases with the same pronunciation as “ [symbol] ” include “ [symbol] ” and “ [symbol] ” or the like. Therefore, the conversion result acquired by using the speech recognition engine may be “ [symbol] ” or “ [symbol] ”, which is not consistent with what the user expects to display.

Therefore, semantic analysis may be performed on the obtained conversion result after using the speech recognition engine to recognize the acquired speech data inputted by the user. In an exemplary embodiment of recognizing the speech data, the speech recognition engine may be used to recognize the speech data inputted by the user and convert the speech data to obtain the conversion result. Then the semantic analysis is performed on the conversion result to obtain a semantic analysis result. The semantic analysis result is used to modify a part of the content in the conversion result, such that the modified content in the conversion result has higher universality and/or stronger logicality, and is more consistent with the expectation of the user. Then, the modified conversion result may be determined as the display content to be finally displayed in the first input box.

For example, the content represented by the speech data inputted by the user is “ [symbol] ”, and the conversion result obtained by using the speech recognition engine is “ [symbol] ”. When the semantic analysis is performed on the conversion result, it is found that the text “ [symbol] ” with the same pronunciation as the conversion result has higher universality in practice. Therefore, the conversion result is modified as “ [symbol] ”, and the modified conversion result is determined as the display content to be displayed in the first input box. For another example, the content represented by the speech data inputted by the user is “ [symbol] ”, while the conversion result possibly obtained after performing recognition and conversion by using the speech recognition engine is “ [symbol] ”. It may be known by performing the semantic analysis on the conversion result, that “ [symbol] ” is not matched with “ [symbol] ”. Then, after the semantic analysis is performed on the conversion result, “ [symbol] ” is modified to “ [symbol] ” based on the subsequent text “ [symbol] ” to obtain the conversion result “ [symbol] ”. It can be seen that the conversion result has stronger logicality and is more consistent with the expectation of the user.

In addition, in some cases, in order to be more consistent with the input content expected by the user, multiple modified conversion results acquired by the semantic analysis may be displayed to the user. The user performs a selection operation on the multiple modified conversion results. Based on the selection operation of the user, the conversion result selected by the user is determined from the multiple modified conversion results as the display content displayable in the first input box. Since the display content is selected by the user from the multiple modified conversion results, the obtained display content is more consistent with the content expected by the user.

It should be noted that multiple conversion results with the same or similar pronunciation may be acquired through the semantic analysis, and multiple related conversion results may also be acquired through an intelligent search in the semantic analysis. For example, the content represented by the speech data inputted by the user is “ [symbol] ”, the words with the same or similar pronunciation may include “ [symbol] ”, “ [symbol] ”, etc., all of which may be determined as the modified conversion results. For example, the content represented by the speech data inputted by the user is “Smartisan”, and an intelligent search is performed with the “Smartisan” to obtain “Smartisan technology co.LTD”, “Beijing Smartisan digital” and other search results. These search results and the “Smartisan” may be determined as the modified conversion results. Therefore, the modified conversion result obtained after the semantic analysis performed on the conversion results acquired by the speech recognition engine may have similar pronunciations and/or may be the search results obtained through the intelligent search.

In step S304, the display content is displayed in the first input box.

The display content may be displayed in the first input box after acquiring the display content displayable in the first input box. In practices, the user may input different contents into the first input box by means of speech inputs for multiple times. In this case, the content inputted by the previous speech input is already displayed in the current first input box. The display content obtained by a new speech input may replace the display content currently displayed in the input box.

For example, the user may perform information retrieval with the Baidu webpage several times, and the text content of “what fruit is delicious” is already inputted in the first input box for the previous information retrieval performed by the user. In a current information retrieval, the user wants to input “how to make a fruit platter” in the first input box. At this time, if the text contents of “what fruit is delicious” and “how to make a fruit platter” are both displayed in the current first input box, a retrieval result to be obtained by the information retrieval of the user with “how to make the fruit platter” may be affected. Therefore, the text “how to make a fruit platter” may replace the text “what fruit is delicious” in the process of inputting the text content “how to make a fruit platter” in the first input box. The first input box is an input box where the user wants to input the content and is displayed on the current display interface.

Therefore, in an exemplary embodiment, it may be determined whether there is any content currently displayed in the first input box, after acquiring the display content displayable in the first input box. If there is some content currently displayed in the first input box, the displayed content in the first input box is deleted and the display content obtained in this speech input is displayed in the first input box. If there is no other content currently displayed in the current first input box, the display content is directly displayed in the first input box. In this way, only the content inputted by the user this time is displayed in the first input box, thereby avoiding that the content previously inputted by the user affects the content inputted by the user this time.

In the embodiment, the speech input control and the related input box are displayed at the same time before the user performs the speech input operation. When the user performs a triggering operation on the first speech input control, the speech data inputted by the user is received in response to the triggering operation, where the first speech input control is a speech input control selected by the user. Then, the speech data inputted by the user is converted into the display content displayable in the first input box, and the display content is displayed in the first input box associated with the first speech input control. Since the speech input control corresponding to the input box is displayed at the same time when the input box is displayed, the user can directly perform the speech input operation on the speech input control, to start the speech input. Compared with the conventional technology, in the technical solution of the present disclosure, the user does not have to click the input box and find the speech input control from the multiple controls on the input control board before the user performs the speech input operation. In this way, not only the operations of the user can be reduced, but also the time of the user is saved, thereby improving the speech input efficiency of the user. Furthermore, the user does not need the speech input control on an input control board to perform the speech input, avoiding the problem that the user cannot perform the speech input due to non-existent of the speech input control on some input control boards.

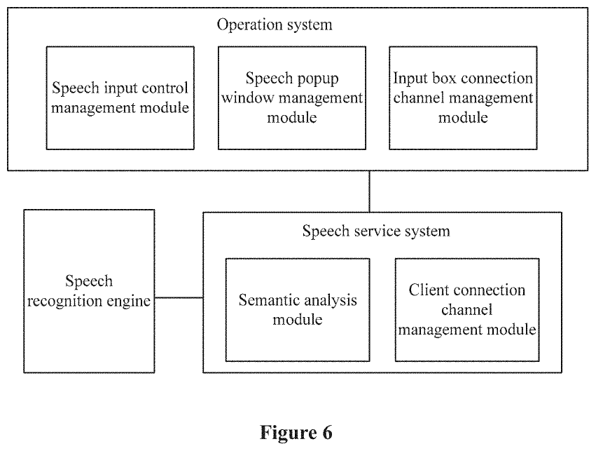

In order to introduce the technical solution of the present disclosure in detail, the embodiment of the present disclosure is described in conjunction with a specific software architecture hereinafter. Reference is made to FIG. 6, which is a schematic diagram of an exemplarv software architecture applied to a content input method according to an embodiment of the present disclosure. In some scenarios, the software architecture may be applied to the terminal.

The software architecture may include an operation system (such as the Android operation system) on the terminal, a speech service system and a speech recognition engine. The operation system may communicate with the speech service system, and the speech service system may communicate with the speech recognition engine. The speech service system may operate in an independent process. In a case where the operation system on the terminal is the Android operation system, the Android operation system may in a data communication or connection with the speech service system via an Android IPC (Inter-Process Communication) interface or a Socket.

The operation system may include a speech input control management module, a speech popup window management module and an input box connection channel management module. When the user starts the client on the terminal, the speech service system is started. In a case where an input box is displayed on the display interface of the client, the speech input control management module may control the speech input control corresponding to the input box to also be displayed on the display interface, where there is a preset correspondence between the speech input control and the input box. In general, the speech input control is in one-to-one correspondence with the input box.

Then, the input box connection channel management module may establish a connection between the input box displayed on the display interface and the speech service system, i.e., a data communication connection channel between the input box and a client connection channel management module in the speech service system, so that the input box connection channel management module receives the conversion result returned by the client connection channel management module through the data communication connection channel.

In a case where the user performs the speech input operation on the first speech input control on the terminal, where the first speech input control is the speech input control selected by the user on the current display interface, the speech input control management module may, in response to the speech input operation of the user, determine whether the speech service system is started and whether it is started abnormally. In a case where the speech service system is not stated or is started abnormally, the speech service system is restarted and the input box connection channel management module is triggered to re-establish the data communication connection channel between the input box and the client connection channel management module in the speech service system. Furthermore, the speech popup window management module may pop up a speech recording popup window, where the speech recording popup window is used for prompting the user to perform the speech input and feeding back the speech input situation to the user. In practices, when the user inputs the speech data in a speech record window, in order to show a difference between a situation of inputting the speech data and a situation of not inputting the speech data, a presentation of the speech recording popup window may be changed at the time when the user inputs the speech data, to be different from the presentation of the speech recording popup window at the time when the user does not input the speech data. In an example, when the user does not input the speech data, the presentation of the speech recording popup window may be as shown as FIG. 4, and when the user inputs the speech data, the presentation of the speech recording popup window may be as shown as FIG. 5.

The speech recognition engine may recognize the speech data and convert the speech data to obtain the conversion result after receiving the speech data inputted by the user. The conversion result may be a computer readable input. For example, in a case where a content of the speech data inputted by the user is “haha”, the conversion result obtained by the conversion performed by the speech recognition engine may be a text “haha”, or a character representing a facial expression “\hat{ }_\hat{ }”, “O(\hat{ }_\hat{ })O ha ha ˜”, or may be an image representing the facial expression “haha” in some scenarios, which is not limited herein.

Then, the speech recognition engine sends the conversion result obtained by the conversion to the semantic analysis module. The semantic analysis module performs the semantic analysis on the conversion result to obtain the semantic analysis result. A part of content in the conversion result is adaptively modified by using the semantic analysis result, such that the content of the modified conversion result has the higher universality and/or the stronger logicality, and is more consistent with the expectation of the user. Then the modified conversion result may be determined as the display content displayable in the first input box.

The semantic analysis module may send the conversion result to the client connection channel management module after acquiring the display content. The client connection channel management module determines the client on the terminal corresponding to the display content, i.e., determining the input box of which client the display content is required to be displayed in. Then, the display content is sent to the input box connection channel management module through the pre-established data communication connection channel between the input box and the client connection channel management module. The input box connection channel management module sends the display content to the corresponding first input box, so as to display the display content in the first input box, thereby achieving the speech input. In the example, the first input box corresponds to the first speech input control, i.e., the input box to be inputted with the content by the user.

Furthermore, in a case where the user stops using the client (i.e. closing the client), or switches from a current display interface of the client to another display interface, the user will not continue to input the content in the first input box. Therefore, the input box connection channel management module may release the data communication connection channel between the first input box and the client connection channel management module, so as to save system resources.

In the embodiment, since the speech input control and the input box are displayed at the same time before the user performs the speech input operation, the user may directly perform the speech input operation on the speech input control associated with the first input box, so as to input the content in the first input box by means of speech input. Compared with a conventional process of performing the speech input, the technical solution of the present disclosure can reduce the operations the user has to perform, and the user does not have to look for the speech input control from the multiple buttons on the input control board. Thus the time of the user for looking for the speech input control is also saved, thereby improving the speech input efficiency of the user and avoiding the problem that the user cannot perform the speech input due to non-existent of the speech input control on some input control boards.

It should be noted that the above software architecture is only illustrative and is not used to limit the application scenarios of the embodiment of the present disclosure. In fact, the embodiment of the present disclosure may also be applied to other scenarios. For example, in some scenarios, it is the server that converts the speech data. Specifically, after the user performs the speech input operation on the first speech input control, the terminal, in response to the speech input operation of the user, receives the speech data inputted by the user, and then sends the speech data to the server. A speech recognition engine provided on the server recognizes the speech data to obtain the conversion result. Then a semantic analysis module provided on the server performs the semantic analysis on the conversion result to obtain the final conversion result. Then, the server sends the conversion result to the terminal, and the terminal determines the input box on the client corresponding to the conversion result and displays the conversion result in the determined input box. Since a computation speed of the server is much higher than the terminal, a response time of the terminal to the speech input can be greatly reduced. Therefore, by providing a service of speech input to a user with this method, a user experience can be improved.

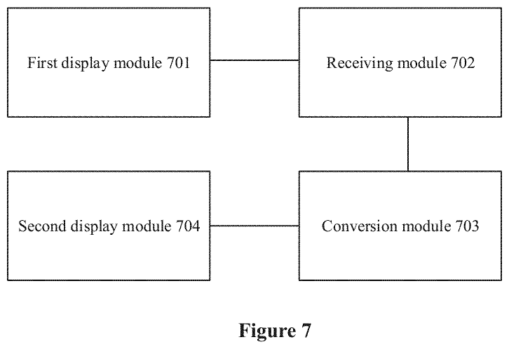

In addition, a content input device is further provided in the embodiment of the present disclosure. Reference is made to FIG. 7, which is a schematic architecture diagram of a content input device according to an embodiment of the present disclosure. The device may include: a first display module 701, a receiving module 702, a conversion module 703 and a second display module 704.

The first display module 701 is configured to display an input box and a speech input control in response to a display event of the input box, where there is a preset correspondence between the input box and the speech input control.

The receiving module 702 is configured to receive speech data in response to a speech input operation on a first speech input control, where the first speech input control is a speech input control selected by a user.

The conversion module 703 is configured to convert the speech data into display content displayable in a first input box, where the first input box corresponds to the first speech input control.

The second display module 704 is configured to display the display content in the first input box.

In some possible embodiments, the first display module 701 may include: a first display unit, a detection unit and a second display unit.

The first display unit is configured to display the input box.

The detection unit is configured to detect whether the input box is displayed.

The second display unit is configured to display the speech input control in a case where it is detected that the input box is displayed.

In some possible embodiments, the first display module 701 may also include a third display unit and a fourth display unit.

The third display unit is configured to display the input box.

The fourth display unit is configured to display the speech input control in response to a triggering operation of the user on a shortcut key, where the shortcut key is associated with the speech input control.

In some possible embodiments, the first display module 701 is configured to display the input box and the speech input control at the same time.

In some possible embodiments, the conversion module 703 may include a conversion unit and a modification unit.

The conversion unit is configured to convert the speech data to obtain a conversion result.

The modification unit is configured to modify the conversion result based on a semantic analysis on the conversion result and determine the modified conversion result as the display content displayable in the first input box.

In some possible embodiments, the modification unit may include: a display sub-unit and a determining sub-unit.

The display sub-unit is configured to display the modified conversion result.

The determining sub-unit is configured to determine the conversion result selected by the user from multiple modified conversion results in response to a selection operation of the user for the modified conversion results and determine the conversion result selected by the user as the display content displayable in the first input box.

The multiple modified conversion results have similar pronunciations, and/or, the multiple modified conversion results are search results obtained through an intelligent search.

In some possible embodiments, the first speech input control is displayed in the first input box and a display position of the first speech input control in the first input box is not fixed but can move with an increase or a decrease of the display content in the first input box.

In some possible embodiments, a presentation of the speech input control includes a speech bubble, a loudspeaker or a microphone or the like.

In some possible embodiments, the second display module 704 may include: a content detection unit and a substitution unit.

The content detection unit is configured to detect whether other display content exists in the first input box when the user inputs the speech data.

The substitution unit is configured to substitute the display content for the other display content in a case where the other display content exists in the first input box.

In the embodiment, since the speech input control and the input box are displayed at the same time before the user performs the speech input operation, the user may directly perform the speech input operation on the speech input control associated with the first input box, so as to input the content in the first input box by means of speech input. Compared with a conventional process of performing the speech input, the technical solution of the present disclosure can reduce the operations the user has to perform, and the user does not have to look for the speech input control from the multiple buttons on the input control board. Thus, the time of the user for looking for the speech input control is also saved, thereby improving the speech input efficiency of the user and avoiding the problem that the user cannot perform the speech input due to non-existent of the speech input control on some input control boards.

It should be noted that the embodiments in the specification are described in a progressive manner, with the emphasis of each of the embodiments on the difference from other embodiments. For the same or similar parts between the embodiments, reference may be made one to another. Since the system or the device disclosed in the embodiments corresponds to the method disclosed in the embodiment, the description for the system or the device is simple, and reference may be made to the method embodiment for the relevant parts.

It should be further noted that the relationship terminologies such as “first”, “second” and the like are only used herein to distinguish one entity or operation from another, rather than to necessitate or imply that the actual relationship or order exists between the entities or operations. Furthermore, terms of “include”. “comprise” or any other variants are intended to be non-exclusive. Therefore, a process, method, article or device including a plurality of elements includes not only the elements but also other elements that are not enumerated, or also include the elements inherent for the process, method, article or device. Unless expressively limited otherwise, the statement “comprising (including) a . . . ” does not exclude the case that other similar elements may exist in the process, method, article or device.

Steps of the method or the algorithm described in conjunction with the embodiments disclosed herein may be implemented directly with hardware, a software module executed by a processor or a combination thereof. The software module may be provided in a Random Access Memory (RAM), a memory, a Read Only Memory (ROM), an electrically-programmable ROM, an electrically erasable programmable ROM, a register, a hard disk, a removable disk, a CD-ROM, or a storage medium in any other forms known in the art.

The above description of the embodiments enables those skilled in the art to implement or use the present disclosure. Multiple modifications to these embodiments are apparent to those skilled in the art, and the general principle defined herein may be implemented in other embodiments without deviating from the spirit or scope of the present disclosure. Therefore, the present disclosure is not limited to these embodiments described herein, and conforms to the widest scope consistent with the principle and novel features disclosed herein.

1. A content input method, comprising:
displaying an input box and a speech input control in response to a display event of the input box, wherein there is a preset correspondence between the input box and the speech input control;
receiving speech data in response to a speech input operation on a first speech input control, wherein the first speech input control is a speech input control selected by a user;
converting the speech data into display content displayable in a first input box, wherein the first input box corresponds to the first speech input control; and
displaying the display content in the first input box.

2. The method according to claim 1, wherein the displaying an input box and a speech input control comprises:
displaying the input box;
detecting whether the input box is displayed; and
displaying the speech input control in a case where the input box is displayed.

3. The method according to claim 1, wherein the displaying an input box and a speech input control comprises:
displaying the input box; and
displaying the speech input control in response to a triggering operation of the user on a shortcut key, wherein the shortcut key is associated with the speech input control.

4. The method according to claim 1, wherein the displaying an input box and a speech input control comprises:
displaying the input box and the speech input control at the same time.

5. The method according to claim 1, wherein the first speech input control is displayed in the first input box, and a display position of the first speech input control in the first input box moves with an increase or a decrease of the display content in the first input box.

6. The method according to claim 1, wherein a presentation of the speech input control comprises a speech bubble, a loudspeaker or a microphone.

7. The method according to claim 1, wherein the converting the speech data into display content displayable in the first input box comprises:
converting the speech data to obtain a conversion result; and
modifying the conversion result based on a semantic analysis on the conversion result and determining the modified conversion result as the display content displayable in the first input box.

8. The method according to claim 7, wherein the determining the modified conversion result as the display content displayable in the first input box comprises:
displaying the modified conversion result; and
determining the conversion result selected by the user from a plurality of modified conversion results in response to a selection operation of the user for the modified conversion results and determining the conversion result selected by the user as the display content displayable in the first input box,
wherein the plurality of modified conversion results have similar pronunciations, and, the plurality of modified conversion results are search results obtained through an intelligent search.

9. The method according to claim 1, wherein the displaying the display content in the first input box comprises:
detecting whether other display content exists in the first input box when the user inputs the speech data; and
substituting the display content for the other display content in a case where the other display content exists in the first input box.

10. A device for inputting content in an input box, comprising:
one or more processors; and
a storage device for storing one or more programs, wherein the one or more programs, when executed by the one or more processors, cause the one or more processors to implement a content input method, the method comprises:
displaying an input box and a speech input control in response to a display event of the input box, wherein there is a preset correspondence between the input box and the speech input control;
receiving speech data in response to a speech input operation on a first speech input control, wherein the first speech input control is a speech input control selected by a user;
converting the speech data into display content displayable in a first input box, wherein the first input box corresponds to the first speech input control; and
displaying the display content in the first input box.

11. The device according to claim 10, wherein the one or more programs, when executed by the one or more processors, cause the one or more processors to implement:
displaying the input box;
detecting whether the input box is displayed; and
displaying the speech input control in a case where it is detected that the input box is displayed.

12. The device according to claim 10, wherein the one or more programs, when executed by the one or more processors, cause the one or more processors to implement:
displaying the input box; and
displaying the speech input control in response to a triggering operation of the user on a shortcut key, wherein the shortcut key is associated with the speech input control.

13. The device according to claim 10, wherein the one or more programs, when executed by the one or more processors, cause the one or more processors to implement: displaying the input box and the speech input control at the same time.

14. The device according to claim 10, wherein the one or more programs, when executed by the one or more processors, cause the one or more processors to implement:
converting the speech data to obtain a conversion result; and
modifying the conversion result based on a semantic analysis on the conversion result and determining the modified conversion result as the display content displayable in the first input box.

15. The device according to claim 14, wherein the one or more programs, when executed by the one or more processors, cause the one or more processors to implement:
displaying the modified conversion result; and
determining the conversion result selected by the user from a plurality of modified conversion results in response to a selection operation of the user for the modified conversion results and determining the conversion result selected by the user as the display content displayable in the first input box,
wherein the plurality of modified conversion results have similar pronunciations, and the plurality of modified conversion results are search results obtained through an intelligent search.

16. A non-transitory computer readable medium storing a computer program, wherein the computer program, when executed by a processor, cause the processor to implement a content input method, the method comprises:
displaying an input box and a speech input control in response to a display event of the input box, wherein there is a preset correspondence between the input box and the speech input control;
receiving speech data in response to a speech input operation on a first speech input control, wherein the first speech input control is a speech input control selected by a user;
converting the speech data into display content displayable in a first input box, wherein the first input box corresponds to the first speech input control; and
displaying the display content in the first input box.

17. The method according to claim 7, wherein the determining the modified conversion result as the display content displayable in the first input box comprises:
displaying the modified conversion result; and
determining the conversion result selected by the user from a plurality of modified conversion results in response to a selection operation of the user for the modified conversion results and determining the conversion result selected by the user as the display content displayable in the first input box,
wherein the plurality of modified conversion results have similar pronunciations, or the plurality of modified conversion results are search results obtained through an intelligent search.

18. The device according to claim 14, wherein the modification unit comprises:
a display sub-unit, configured to display the modified conversion result; and
a determining sub-unit, configured to determine the conversion result selected by the user from a plurality of modified conversion results in response to a selection operation of the user for the modified conversion results and determine the conversion result selected by the user as the display content displayable in the first input box,
wherein the plurality of modified conversion results have similar pronunciations, or the plurality of modified conversion results are search results obtained through an intelligent search.
